(19) United States
(12) Patent Application Publication
(10) Pub. No.: US 2020/0114241 A1
(43) Pub. Date: Apr. 16, 2020

(54) System and Method for Real-time Tracking and Displaying of an Athlete's Motions

(71) Applicant: Patrick XU, Cupertino, CA (US)

(72) Inventor: Patrick XU, Cupertino, CA (US)

(21) Appl. No.: 16/596,363

(22) Filed: Oct. 8, 2019

Related U.S. Application Data
(60) Provisional application No. 62/745,617, filed on Oct. 15, 2018.

(51) Int. Cl. A63B 71/06; G09B 19/00; A63B 24/00; A63B 33/00

(52) U.S. Cl. CPC A63B 71/0622; G09B 19/0038; A63B 24/0062; A63B 33/002; A63B 2071/0666; A63B 2024/0068; A63B 2220/836; A63B 2225/52; A63B 2220/40; A63B 2220/34; A63B 2244/20; A63B 2071/0647

(57) ABSTRACT

The present disclosure relates to system and method for real-time tracking and displaying of an athlete's motions. The disclosure includes of a system for tracking the movement of key parts of the human body, then transmitting data acquired to create a visual of the movement of the body within a viewing device. The system includes a plurality of sensor devices attached to various parts of the athlete's body that are configured to collect sensor data about movements of an athlete's body, a controller configured to process the sensor data received from the plurality of sensor devices to generate one or more views of the movements of the athlete's body, and a display module configured to display the one or more views of the movements of the athlete's body.

### CLAIM OF PRIORITY UNDER 35 U.S.C. § 119

This application claims the benefit of U.S. provisional patent application No. 62/745,617, “System and Method for Real-time Tracking and Displaying of an Athlete's Motions,” filed Oct. 15, 2018. The aforementioned United States patent application is hereby incorporated by reference in its entirety.

### FIELD OF THE INVENTION

The present disclosure relates to the field of consumer electronics. In particular, the present disclosure relates to system and method for real-time tracking and displaying of an athlete's motions.

### BACKGROUND

Competitive athletics is an area where many people participate in. Achieving a stroke most efficient and powerful for them is a goal many athletes strive to achieve, so they can generate the most power with the least amount of energy expended. This is currently done through recordings of the races or coach advice from observation; however, these are both fallible, as the recordings are not in perfect detail, and the coach cannot pick up or display every minute detail. Even with a stroke concept by the athlete or coach, it is hard for athletes to realize that stroke through bodily perception; the human senses are fallible and accustomed to habitual movement and muscle memory, so what may feel like a drastic change may not be a change in reality. Therefore, a need exists for a system capable of objectively demonstrating the stroke and movement of athletes to them in real-time so they may make the necessary adjustments at the right time.

### SUMMARY

The present disclosure relates to system and method for real-time tracking and displaying of an athlete's motions. In one embodiment, a method for tracking and displaying of an athlete's motions includes collecting by a plurality of sensor devices sensor data about movements of an athlete's body, where the plurality of sensor devices are attached to various parts of the athlete's body, processing by a controller the sensor data received from the plurality of sensor devices to generate one or more views of the movements of the athlete's body, and displaying by a display module the one or more views of the movements of the athlete's body.

The method further includes preloading by the controller one or more reference views of desired movements of the athlete's body, and displaying by the display module the one or more views of the movements of the athlete's body and the one or more reference views of desired movements of the athlete's body.

A system for tracking and displaying of an athlete's motions includes a plurality of sensor devices attached to various parts of the athlete's body that are configured to collect sensor data about movements of an athlete's body, a controller configured to process the sensor data received from the plurality of sensor devices to generate one or more views of the movements of the athlete's body, and a display module configured to display the one or more views of the movements of the athlete's body.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIG. 1 illustrates a system for real-time tracking and displaying of an athlete's motions according to aspects of the present disclosure.

FIG. 2 illustrates an exemplary implementation of a sensor device of the system shown in FIG. 1 according to aspects of the present disclosure.

FIG. 3 illustrates an exemplary implementation of a controller of the system shown in FIG. 1 according to aspects of the present disclosure.

FIG. 4 illustrates an exemplary implementation of a display of the system shown in FIG. 1 according to aspects of the present disclosure.

FIG. 5A illustrates an exemplary application of the system shown in FIG. 1 according to aspects of the present disclosure.

FIG. 5B illustrates another view of the exemplary application of the system shown in FIG. 1 according to aspects of the present disclosure.

FIG. 6A illustrates an exemplary implementation of a display module of the system shown in FIG. 1 according to aspects of the present disclosure.

FIG. 6B illustrates the display module of FIG. 6A during a real-time display of an athlete's motions according to aspects of the present disclosure.

FIG. 6C illustrates another example of a real-time display of an athlete's motions according to aspects of the present disclosure.

FIG. 6D illustrates yet another example of a real-time display of an athlete's motions according to aspects of the present disclosure.

FIG. 6E illustrates yet another example of a real-time display of an athlete's motions according to aspects of the present disclosure.

FIG. 6F illustrates yet another example of a real-time display of an athlete's motions according to aspects of the present disclosure.

FIG. 7A illustrates an exemplary method for real-time tracking and displaying of an athlete's motions according to aspects of the present disclosure.

FIG. 7B illustrates an exemplary method for comparing views of movements of an athlete's body to reference views of desired movements of an athlete's body according to aspects of the present disclosure.

FIG. 7C illustrates another exemplary method for comparing views of movements of an athlete's body to reference views of desired movements of an athlete's body according to aspects of the present disclosure.

FIG. 7D illustrates an exemplary method of collecting sensor data about movements of an athlete's body according to aspects of the present disclosure.

FIG. 7E illustrates an exemplary method of processing the sensor data received from the plurality of sensor devices according to aspects of the present disclosure.

FIG. 7F illustrates another exemplary method of processing the sensor data received from the plurality of sensor devices according to aspects of the present disclosure.

FIG. 7G illustrates exemplary methods of displaying the one or more views of the movements of the athlete's body according to aspects of the present disclosure.

### DESCRIPTION OF EMBODIMENTS

System and method are provided for real-time tracking and displaying of an athlete's motions. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the spirit and scope of the invention. Thus, the present disclosure is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

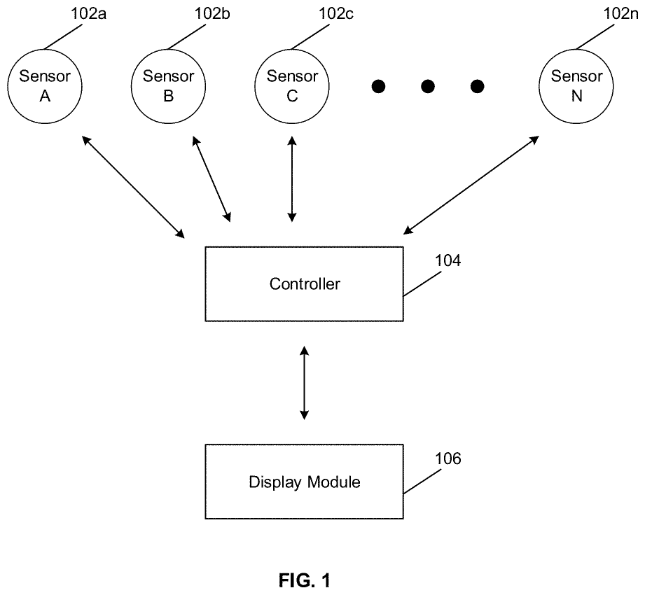

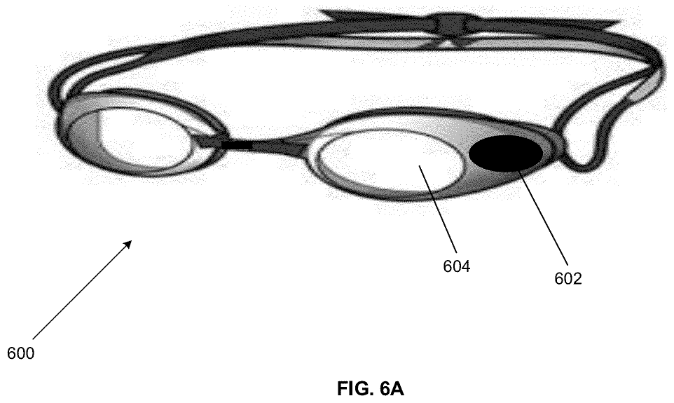

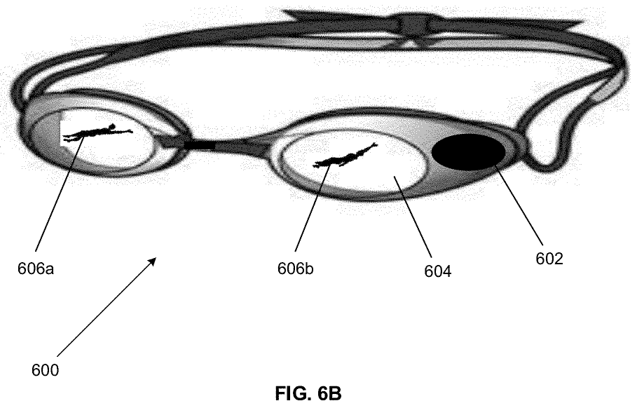

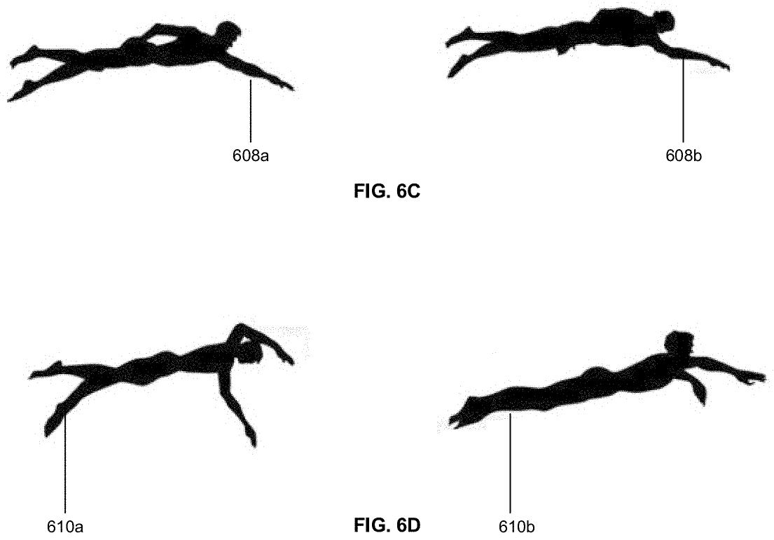

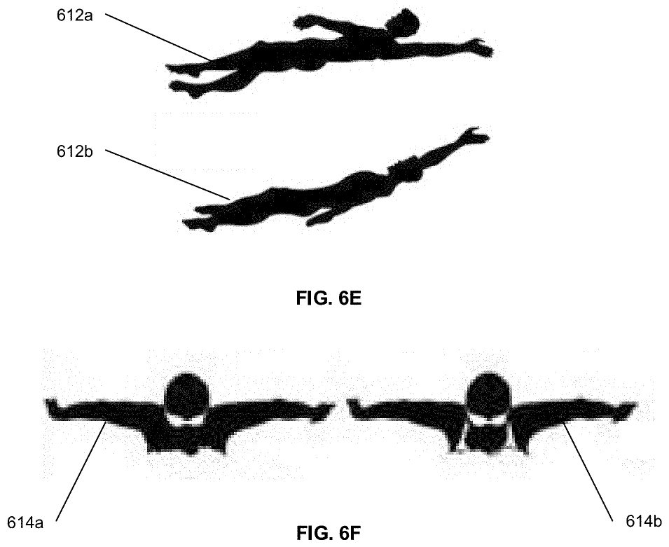

FIG. 1 illustrates a system for real-time tracking and displaying of an athlete's motions according to aspects of the present disclosure. As shown in FIG. 1, the system for real-time tracking and displaying of an athlete's motions may include a plurality of insulated sensor devices, 102a to 102n, each with an attachment mechanism as to be placed on key parts of the athlete's body and Bluetooth capability to transmit data. Each sensor in the plurality of sensor devices may include 3 axis accelerometers and 3 axis gyroscope sensors that are configured to measure the speed, inertial motion, orientation, and angular velocity in order to ascertain positions of key parts of the athlete's body and accurately track rotation and movement through calculations done by a controller 104. The sensor devices (102a through 102n) can be paired and calibrated to judge relative distance with respect to the controller 104 to generate maps (also referred to as views) of the athlete's body at its current position. The controller, with an attachment mechanism such as straps or built-in to the athlete's uniform (such as the body suit of a swimmer), can be located in a centralized location of the athlete to receive data, via Bluetooth or other wireless means, from the sensor devices (102a through 102n) and relay it to a display module 106 in real time via Bluetooth or other wireless means, or for review in a later time. The display module 106 may include a pair of goggles, as described below in association with FIG. 6A and FIG. 6B, with a display screen lodged between two layers of goggle lens, can be configured to receive and display data from the controller 104 to provide an accurate display of the athlete's body. The athlete's body positions can be viewed from multiple angles by toggling the display. The screen of the display may be translucent and cover the outer halves of the goggles as to not impede vision for the user.

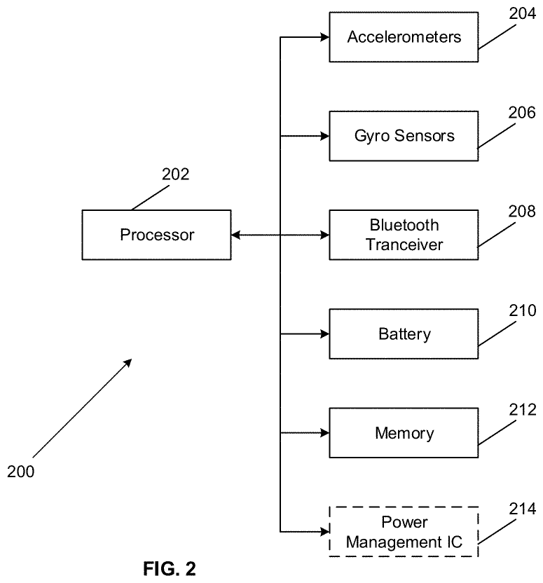

FIG. 2 illustrates an exemplary implementation of a sensor device of the system shown in FIG. 1 according to aspects of the present disclosure. Each sensor device 200 can be configured to track the inertial motion, angular velocity, and orientation of each part it is attached to, and be able to collect and/or process the data and transmit the data to the controller through a Bluetooth transceiver using Bluetooth Low Energy (BLE). It may include a printed circuit board (PCB) to connect components together and a battery to power the various functions of the sensor devices. The sensor devices can be used underwater without damage or complications.

In the example shown in FIG. 2, the sensor device 200 may include one or more or combinations of followings: 1) a processor 202 configured to control the various components of the sensor device 200; 2) 3 axis accelerometers 204 configured to measure movement, displacement, and speed of the athlete's body; 3) 3 axis gyro sensors 206 with three degrees of freedom to measure inertial motion, angular velocity, and orientation of the athlete's body; 4) a Bluetooth transceiver 208 configured to transmit collected data to the controller for processing using BLE. 5) a battery 210; 6) a memory 212 configured to store sensor data; 7) an optional power management integrated circuit 214 configured to control power consumption of the sensor device 200, and 8) a flexible printed circuit board (not shown) to connect and integrate the above components together. The sensor device 200 can be encased in a waterproof housing to protect from potential water damage, as well as have an attachment mechanism, such as strap or built-in to the athlete's uniform, to anchor the sensor device to a key part of the body. In some implementations, the processor 202 may be implemented as a System on Chip (SoC) with embedded processor to process data collected locally. The Bluetooth transceiver 208 may optionally include an amplifier to amplify the transmission signal to the controller.

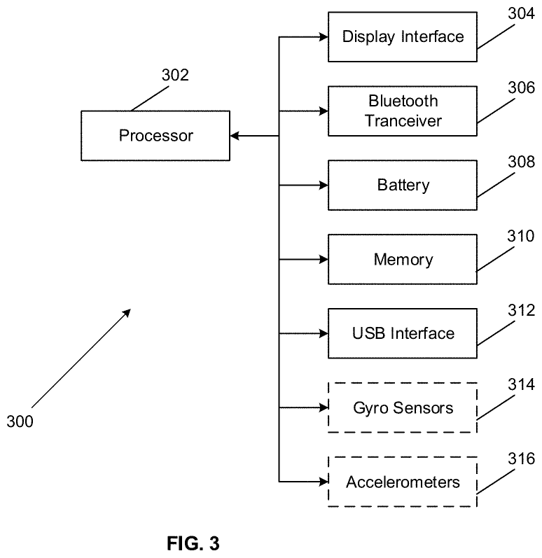

FIG. 3 illustrates an exemplary implementation of a controller of the system shown in FIG. 1 according to aspects of the present disclosure. The controller 300 can be configured to receive data collected by the sensing devices through Bluetooth, and process and calculate data received to generate maps of the athlete's body. The generated maps can be toggle-able to show different perspectives on the athlete's body. The controller 300 can be configured to receive data through an external source using a USB (Universal Serial Bus) port, and use that data to generate a reference map of the athlete's body to superimpose upon a generated map of the athlete's body, as to provide a tangible display of what the athlete needs to adjust for. The controller 300 can be configured to record and store data for transmission or download to another device for further analysis. The controller 300 may be placed in a centralized location of the athlete, such as near the chest. The controller 300 may be encased in a waterproof housing for use underwater without complications.

In the example shown in FIG. 3, the controller 300 may include one or more or combination of followings: 1) a processor 302; 2) a display interface 304; 3) a Bluetooth transceiver 306, 4) a battery 308; 5) a flash memory 310; 6) a USB interface 312; 7) optional 3 axis gyro sensors 314 and 3 axis accelerometers 316; and 8) a flexible PCB (not shown) to connect and integrated the above components. In some implementations, the processor 302 may be implemented as a SoC with an embedded processor and Random Access Memory (RAM). The display interface 304 may be implemented with MIPI-DSI (Mobile Industry Processor Interface—Display Serial Interface) compatibility.

According to aspects of the present disclosure, the controller 300 may serve as an anchor point of the sensor network for determining the relative location of each sensing device. Additional calibration can be performed based off the anchor point to increase accuracy. The controller 300 is configured to receive sensor data from the sensor devices, process the sensor data, and transmit the processed data to the display module for display. Since using Bluetooth low energy (BLE) to transmit data in water can be unreliable over certain range, thus sending signals to a centralized location also improves the integrity of the sensor data received.

The processor 302 may be configured with MIPI-DSI support to link the processor 302 and the display module for displaying maps of the athlete's body. The processor 302 may be further configured to compute data, calculate relative location of the sensing device from the initial position and subsequently measure inertial motion, angular velocity, and orientation, and generate maps of the user body for display by linking each sensor position.

The display interface 304 is configured to support a display device to be connected to the controller 300, and display data processed by the controller 300. The Bluetooth transceiver 306 may be configured to receive data collected by the sensor network. The battery 308 is configured to provide to power to the various components of the controller 300. The memory 310 may be configured to store information related to the positions of sensing devices; and clock information to ascertain when data was collected and displayed. The USB interface 312 may be configured to input data of a reference stroke to be superimposed over the actual stroke in real time. The controller may further include a button (not shown) that can be configured to toggle between the maps of the athlete's body for viewing, from top and bottom views to side views.

According to aspects of the present disclosure, the flash memory 310 can be configured to keep data of entire training session, then transmit or download to another device, such as laptop, PC, mobile phone etc. for further analysis.

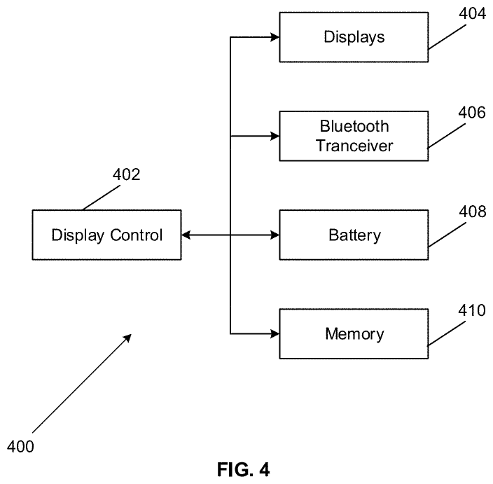

FIG. 4 illustrates an exemplary implementation of a display module of the system shown in FIG. 1 according to aspects of the present disclosure. In the exemplary implementation of FIG. 4, the display module 400 may include a display control 402, one or more displays 404, a Bluetooth transceiver 406, a battery 408 and memory 410.

The display module 400 can be configured to display maps of the athlete's body from data processed by the controller, and can be toggle-able via a button on the controller to show different perspectives on the athlete's body for viewing. The display module 400 can be implemented as a goggle with display screens supported within the lenses to prevent complications.

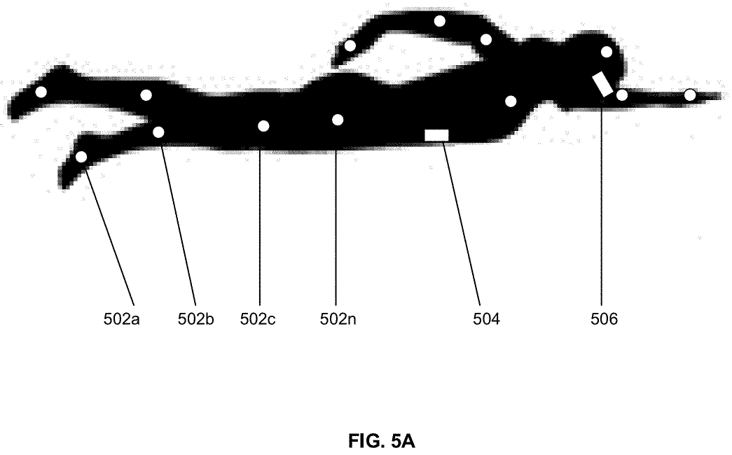

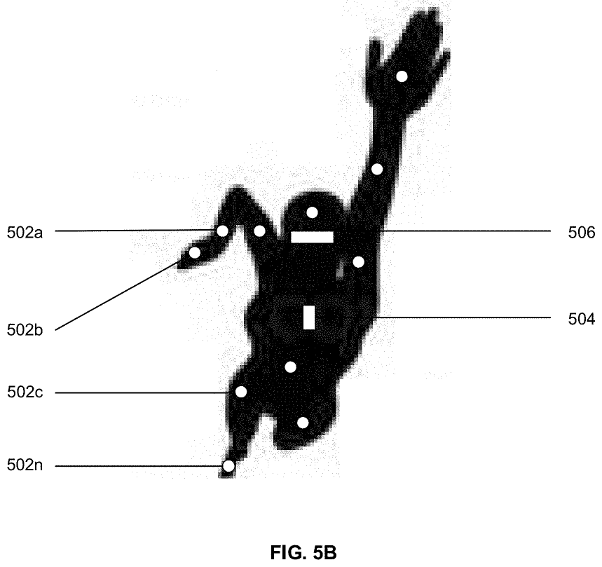

FIG. 5A illustrates an exemplary application of the system shown in FIG. 1 according to aspects of the present disclosure. As shown in the exemplary application of FIG. 5A, the system includes a plurality of sensor devices (for example 502a through 502n) represented by white circles, a controller 504 (represented by a first white rectangle), and a display module 506 (represented by a second white rectangle).

According to aspects of the present disclosure, a plurality of sensor devices (502a through 502n) can be configured to collect data on movement of key parts of the body, with a sensor device on each key part of the body. For example, a sensor may be placed on or near every single big body part; forearms, biceps, hands, quads, feet, calves, pectoral areas, head, chest, back muscles, hamstrings, and hips. The primary functions of the plurality of sensor devices (502a through 502n) are to collect movements, such as speed, rotation, relative position, etc., and transmit data to the controller 504. In some implementations, the plurality of sensor devices may optionally be configured to perform certain processing of the sensor data collected prior transmitted the sensor data to the controller 504. The controller 504 may be configured to process the sensor data received from the plurality of sensor devices to generate maps of the athlete's body, and transmit the maps of the athlete's body to the display module 506 for display.

FIG. 5B illustrates another view of the exemplary application of the system shown in FIG. 1 according to aspects of the present disclosure. Similar to the exemplary application of the system shown in FIG. 5a, the system includes a plurality of sensor devices (for example 502a through 502n) represented by white circles, a controller 504, and a display module 506.

FIG. 6A illustrates an exemplary implementation of a display module of the system shown in FIG. 1 according to aspects of the present disclosure. As shown in FIG. 6A, the components of a display module 602 may be embedded in a special goggle 600 for display of data received from the controller. In some implementations, a MIPI supported display module may be wedged inside the goggle 600, occupying the outer half of space of each lens 604 (also referred to as the screen of the goggles). The lens 604 may be translucent so as to not impair vision of the athlete. The lens may be connected to the components of a display module 602 via wire inside the goggle straps. Information received from the controller can be displayed on the lens 604 inside the goggles. Or it can display wirelessly the data from controller.

FIG. 6B illustrates the display module of FIG. 6A during a real-time display of an athlete's motions according to aspects of the present disclosure. The components of the goggle 600 are the same as the components of the goggle 600 described in FIG. 6A, and they are not described here. In the example shown in FIG. 6B, each lens 606a or 606b may be configured to display an individual view of the athlete's body. The controller may be configured to toggle between the different views for display.

FIG. 6C illustrates another example of a real-time display of an athlete's motions according to aspects of the present disclosure. In this example, a reference view 608a may be shown on one lens of the goggle 600 and an actual view 608b of the athlete's motion and body may be shown on the other lens of the goggle 600. With the two views, the athlete can have an interactive feedback of his motions in comparison to the reference view, and make adjustments during practice. As a result, one of the benefits of the disclosed system is that it can help the athlete to make timely adjustments and corrections, and thus improve the efficiency and quality of his practice. In other implementations, the two views 608a and 608b may be superimposed over each other to allow the athlete to see the differences between his stroke and the reference stroke.

FIG. 6D illustrates yet another example of a real-time display of an athlete's motions according to aspects of the present disclosure. Similar to the example shown in FIG. 6C, a reference view 610a may be shown on one lens of the goggle 600 and an actual view 610b of the athlete's motion and body may be shown on the other lens of the goggle 600. The reference view 610a may be provided by the coach and preloaded to the system before practice. During practice, the athlete can have an interactive feedback of his motions in comparison to the reference view, and make adjustments without taking time to talk to the coach and receiving comments from the coach.

FIG. 6E illustrates yet another example of a real-time display of an athlete's motions according to aspects of the present disclosure. In this example, a reference view 612a and an actual view 612b of the athlete's motion and body may be shown on either the left or the right lens of the goggle 600. The two views are stacked vertically so that the athlete can have a better display of the differences between the actual view 612b of his motions compared to that of the reference view 612a.

FIG. 6F illustrates yet another example of a real-time display of an athlete's motions according to aspects of the present disclosure. In this example, a reference view 614a and an actual view 614b of the athlete's motion and body may be shown side-by-side in the left and the right lens of the goggle 600, or either in the left or the right lens of the goggle 600. The approach may provide the athlete a better display of the differences between the actual views 614b of his motions compared to that of the reference view 614a.

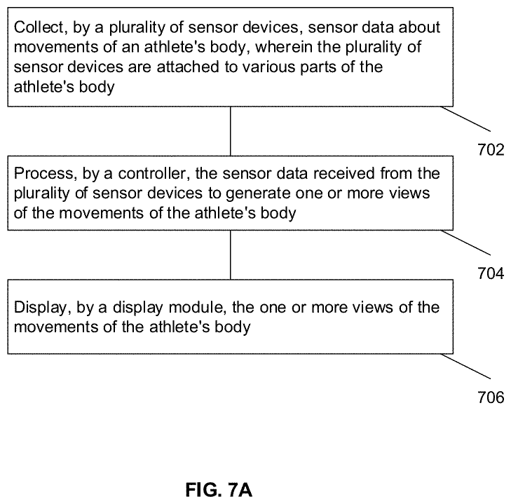

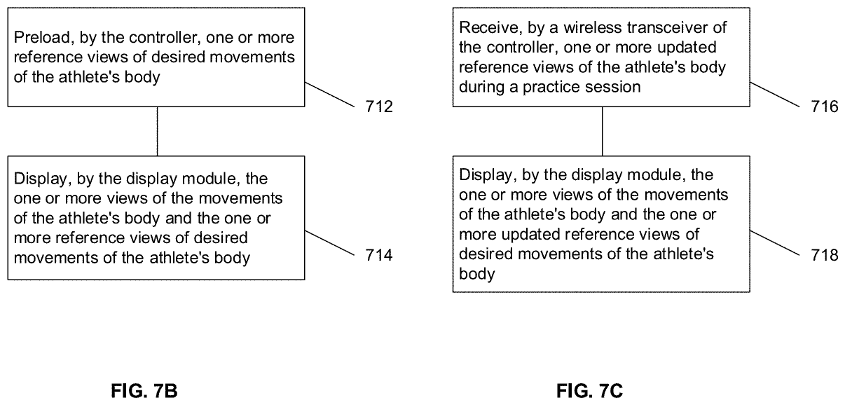

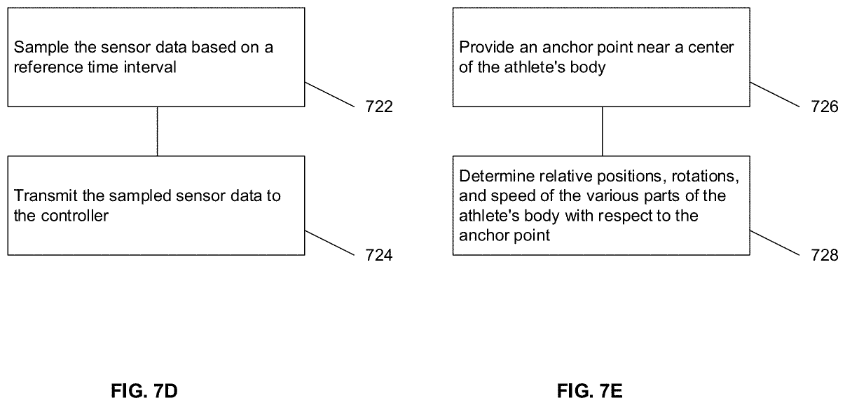

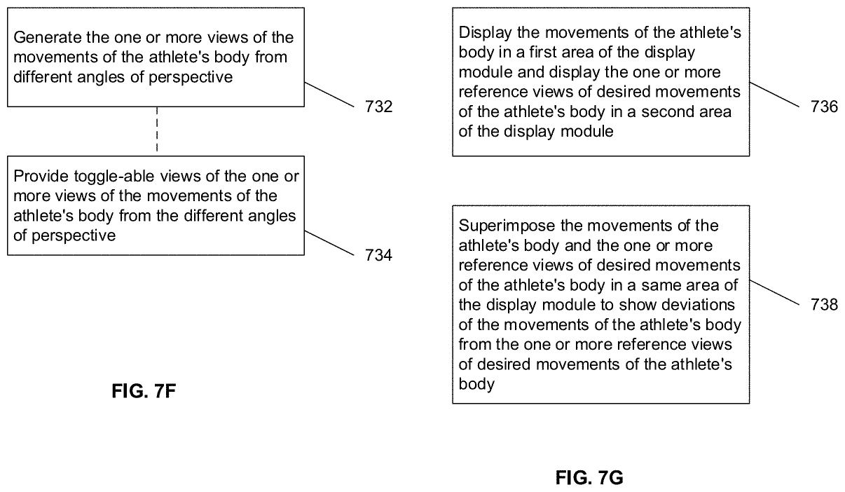

FIG. 7A illustrates an exemplary method for real-time tracking and displaying of an athlete's motions according to aspects of the present disclosure. In the example shown in FIG. 7A, in block 702, the method collects, by a plurality of sensor devices, sensor data about movements of an athlete's body, where the plurality of sensor devices are attached to various parts of the athlete's body. In block 704, the method processes, by a controller, the sensor data received from the plurality of sensor devices to generate one or more views of the movements of the athlete's body. In block 706, the method displays, by a display module, the one or more views of the movements of the athlete's body.

FIG. 7B illustrates an exemplary method for comparing views of movements of an athlete's body to reference views of desired movements of an athlete's body according to aspects of the present disclosure. In block 712, the method preloads, by the controller, one or more reference views of desired movements of the athlete's body. In block 714, the method displays, by the display module, the one or more views of the movements of the athlete's body and the one or more reference views of desired movements of the athlete's body.

FIG. 7C illustrates another exemplary method for comparing views of movements of an athlete's body to reference views of desired movements of an athlete's body according to aspects of the present disclosure. As shown in FIG. 7C, in block 716, the method receives, by a wireless transceiver of the controller, one or more updated reference views of the athlete's body during a practice session. In block 718, the method displays, by the display module, the one or more views of the movements of the athlete's body and the one or more updated reference views of desired movements of the athlete's body.

FIG. 7D illustrates an exemplary method of collecting sensor data about movements of an athlete's body according to aspects of the present disclosure. In the example of FIG. 7D, in block 722, the method samples the sensor data based on a reference time interval. In block 724, the method transmits the sampled sensor data to the controller. In such a way, the amount of sensor date to be transmitted to the controller can be significantly reduced, based on the reference time interval, for example every 0.1 second or other durations suitable for the particular sport being monitored. In some implementations, the plurality of sensor devices may be built-in to a suit worn by the athlete. In some other implementations, when the athlete does not wear a suit that has sensor devices built-in, the plurality of sensor devices may be attached to various parts of the athlete's body via other means, such as by using straps or adhesive means.

FIG. 7E illustrates an exemplary method of processing the sensor data received from the plurality of sensor devices according to aspects of the present disclosure. In block 726, the method provides an anchor point near a center of the athlete's body. In block 728, the method determines relative positions, rotations, and speed of the various parts of the athlete's body with respect to the anchor point.

FIG. 7F illustrates another exemplary method of processing the sensor data received from the plurality of sensor devices according to aspects of the present disclosure. In block 732, the method generates the one or more views of the movements of the athlete's body from different angles of perspective. According to aspects of the present disclosure, the method performed in block 732 may optionally or additionally include the method performed in block 734. In block 734, the method provides toggle-able views of the one or more views of the movements of the athlete's body from the different angles of perspective.

FIG. 7G illustrates exemplary methods of displaying the one or more views of the movements of the athlete's body according to aspects of the present disclosure. In block 736, the method displays the movements of the athlete's body in a first area of the display module and display the one or more reference views of desired movements of the athlete's body in a second area of the display module.

In block 738, the method superimposes the movements of the athlete's body and the one or more reference views of desired movements of the athlete's body in a same area of the display module to show deviations of the movements of the athlete's body from the one or more reference views of desired movements of the athlete's body.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way. Indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. A method for tracking and displaying of an athlete's motions, comprising:
collecting, by a plurality of sensor devices, sensor data about movements of an athlete's body, wherein the plurality of sensor devices are attached to various parts of the athlete's body;
processing, by a controller, the sensor data received from the plurality of sensor devices to generate one or more views of the movements of the athlete's body; and
displaying, by a display module, the one or more views of the movements of the athlete's body.

2. The method of claim 1, further comprising:
preloading, by the controller, one or more reference views of desired movements of the athlete's body; and
displaying, by the display module, the one or more views of the movements of the athlete's body and the one or more reference views of desired movements of the athlete's body.

3. The method of claim 2, further comprising:
receiving, by a wireless transceiver of the controller, one or more updated reference views of the athlete's body during a practice session; and
displaying, by the display module, the one or more views of the movements of the athlete's body and the one or more updated reference views of desired movements of the athlete's body.

4. The method of claim 1, wherein:
the plurality of sensor devices are built-in to a suit worn by the athlete.

5. The method of claim 1, wherein collecting sensor data about movements of an athlete's body comprises:
sampling the sensor data based on a reference time interval; and
transmitting the sampled sensor data to the controller.

6. The method of claim 1, wherein processing the sensor data received from the plurality of sensor devices comprises:
providing an anchor point near a center of the athlete's body; and
determining relative positions, rotations, and speed of the various parts of the athlete's body with respect to the anchor point.

7. The method of claim 1, wherein processing the sensor data received from the plurality of sensor devices further comprises:
generating the one or more views of the movements of the athlete's body from different angles of perspective.

8. The method of claim 7, further comprising:
providing toggle-able views of the one or more views of the movements of the athlete's body from the different angles of perspective.

9. The method of claim 2, wherein displaying the one or more views of the movements of the athlete's body comprises:
displaying the movements of the athlete's body in a first area of the display module and display the one or more reference views of desired movements of the athlete's body in a second area of the display module.

10. The method of claim 2, wherein displaying the one or more views of the movements of the athlete's body further comprises:
superimposing the movements of the athlete's body and the one or more reference views of desired movements of the athlete's body in a same area of the display module to show deviations of the movements of the athlete's body from the one or more reference views of desired movements of the athlete's body.

11. A system for tracking and displaying of an athlete's motions, comprising:
a plurality of sensor devices configured to collect sensor data about movements of an athlete's body, wherein the plurality of sensor devices are attached to various parts of the athlete's body;
a controller configured to process the sensor data received from the plurality of sensor devices to generate one or more views of the movements of the athlete's body; and
a display module configured to display the one or more views of the movements of the athlete's body.

12. The system of claim 11, further comprising:
the controller is further configured to preload one or more reference views of desired movements of the athlete's body; and
the display module is further configured to display the one or more views of the movements of the athlete's body and the one or more reference views of desired movements of the athlete's body.

13. The system of claim 12, further comprising:
a wireless transceiver of the controller configured to receive one or more updated reference views of the athlete's body during a practice session; and
the display module is configured to display the one or more views of the movements of the athlete's body and the one or more updated reference views of desired movements of the athlete's body.

14. The system of claim 11, wherein:
the plurality of sensor devices are built-in to a suit worn by the athlete.

15. The system of claim 11, wherein the plurality of sensor devices are further configured to:
sample the sensor data based on a reference time interval; and
transmit the sampled sensor data to the controller.

16. The system of claim 11, wherein the controller is further configured to:
provide an anchor point near a center of the athlete's body; and
determine relative positions, rotations, and speed of the various parts of the athlete's body with respect to the anchor point.

17. The system of claim 11, wherein the controller is further configured to:
generate the one or more views of the movements of the athlete's body from different angles of perspective.

18. The system of claim 17, wherein the controller is further configured to:
provide toggle-able views of the one or more views of the movements of the athlete's body from the different angles of perspective.

19. The system of claim 12, wherein the display module is further configured to:
display the movements of the athlete's body in a first area of the display module and display the one or more reference views of desired movements of the athlete's body in a second area of the display module.

20. The system of claim 12, wherein the display module is further configured to:
superimpose the movements of the athlete's body and the one or more reference views of desired movements of the athlete's body in a same area of the display module to show deviations of the movements of the athlete's body from the one or more reference views of desired movements of the athlete's body.
